(19) United States
(12) Patent Application Publication
(10) Pub. No.: US 2010/0169896 A1
(43) Pub. Date: Jul. 1, 2010

(54) ELECTRONIC DEVICE AND METHOD OF CONTROLLING A COMMUNICATION

(75) Inventors: Martinus Theodorus Bennebroek, Eindhoven (NL); Kees Gerard Willem Goossens, Eindhoven (NL); Hubertus Gerardus Hendrikus Vermeulen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,304

(22) PCT Filed: Aug. 7, 2007
(86) PCT No.: PCT/IB07/53105

§ 371 Date: Feb. 4, 2009

(30) Foreign Application Priority Data
Aug. 8, 2006 (EP) 06118577.3

(51) Int. Cl. G06F 15/80; G06F 9/06; G06F 9/46; G06F 13/14

(52) U.S. Cl. 719/318; 712/11; 710/305; 712/E09.003

(57) ABSTRACT

An electronic device is provided which comprises a plurality of processing units (IP; IP1-IP4), an interconnect (IPCU; N) for coupling the processing units (IP; IP1-IP4) to enable a communication between the processing units (IP; IP1-IP4) and at least one event monitor (EM) for detecting events in the communication in the electronic device. The electronic device furthermore comprises a first controller unit for controlling the interconnect (IPCU; N) according to one or more of the events detected by the at least one event monitor (EM).

### FIELD OF THE INVENTION

The present invention relates to an electronic device and a method of controlling the communication in an electronic device.

### BACKGROUND OF THE INVENTION

Within recent years, electronic circuits or Integrated Circuits (ICs) have become increasingly more complex with respect to their functionality, their number of programmable components, and their communication. Therefore, the complexity of software and hardware (co-) design increases accordingly and an efficient verification, debug, and optimization is required.

In the design and manufacturing of state-of-the-art ICs, including ASIC, ASSP, FPGA, PLD, CPLD and structured ASIC devices, the control of digital programmable components upon user-interaction or (a sequence of) events is enabled and heavily exploited in (software and hardware) design verification and silicon debug. In www.arm.com/products/solutions/CoreSight.html, control systems are shown that are able to handle single or multiple programmable components. By enforcing a consistent level of control of programmable components from software to hardware definition and implementation, a high system transparency is achieved enabling the relation of silicon (performance) analysis to software and hardware debug and optimization. Similar control systems are frequently implemented in the design of hardwired components, e.g. dedicated (partially- or non-programmable/configurable) accelerators like I/O interfaces, even though the control systems are typically removed once design bottlenecks/bugs have been identified and solved. The implementation of control systems for hardwired components in actual silicon prototypes/products is more difficult as it has to be established prior to IC manufacturing where to put what breakpoints. In addition, these systems often exhibit run-time data-dependent behavior, making it extremely difficult, if not impossible, to accurately determine up-front when key on-chip events occur.

### SUMMARY OF THE INVENTION

It is an object of the invention to provide an electronic device with improved control over the communication within the electronic device.

The invention provides an electronic device according to claim 1, and a method of controlling the communication in an electronic device according to claim 16. The dependent claims define advantageous embodiments.

Therefore, an electronic device is provided which comprises a plurality of processing units, an interconnect for coupling the processing units to enable the communication between the processing units and at least one event monitor for detecting events in the communications between the processing units of the electronic device. The electronic device furthermore comprises a first controller unit for controlling the interconnect according to one or more of the events detected by the at least one event monitor.

According to an aspect of the invention, the controller unit comprises a monitor controller for controlling the interconnect and/or an interconnect controller for controlling the communication between the processing units.

According to a further aspect of the invention, the monitor controller is adapted to update settings in the event monitor, in the processing units and/or in the interconnect controller.

According to still a further aspect of the invention, an event monitor is associated to at least one of the processing units, the interconnect and/or an I/O interface or a monitor interface.

According to a further aspect of the invention, the event monitor, the monitor controller and/or the interconnect controller operate on transactions.

According to still a further aspect of the invention, the event includes predefined or programmable sequences of predefined or programmable events.

According to an aspect of the invention, the controller unit is adapted to control the interconnect to perform predefined or programmable sequences of predefined or programmable operations and/or actions.

According to an aspect of the invention, the programmable operations may constitute control-oriented and/or data-oriented operations. The control-oriented operations include stopping, single-stepping, multi-stepping, continuing and reset operations. The data-oriented operations include download and upload of interconnect states or states of the processing units.

According to an aspect of the invention, the granularity of the control-oriented operations can be on a clock cycle level, on a handshake level, on requests or responses, on transactions or on groups of transactions.

The invention also relates to a method of controlling a communication in an electronic device and/or a system on chip having a plurality of processing units and an interconnect for coupling the processing units to enable a communication between the processing units. Events in a communication between the processing units are detected. The interconnect is controlled according to the events detected by the at least one event monitor.

The invention also relates to a system on chip which comprises a plurality of processing units, an interconnect for coupling the processing units to enable the communication between the processing units and at least one event monitor for detecting events in the communications between the processing units of the system on chip. The system on chip furthermore comprises a first controller unit for controlling the interconnect according to one or more of the events detected by the at least one event monitor.

The invention relates to the idea to take advantage of the convergence of hardware and software co-design. At the highest abstraction level of hardware design, components of an electronic device are communicating to each other via high-level data representations, called transactions, i.e. transaction level. At the lowest level of software design abstraction, i.e. where software has been mapped onto the programmable components of the system, again transaction-level models are used to analyze, verify, and tune the application software. This makes the transaction-level the common denominator for both software and hardware designers, such that software and hardware engineers can share the same view of the actual behavior of the system, enhancing the localization of any remaining hardware and software errors or inefficiencies. This in turn leads to a significant reduction in time-to-market and, when properly fed back to the design community, tools and flows, to an improvement of the product creation process.

Examples of transactions include read (load), load linked, write (store), conditional write, tagged or acknowledged write, flush, test and set, semaphore operations, etc. Examples of transactions can be found in on-chip and board-level communication protocols such as VPB, APB, AHB, AXI, VCI, OCP, DTL, STBus, MIPI, PCIExpress, PCI, and so on. These transactions include a request and optional response phase. The definition of transaction here, includes message passing protocols. These protocols commonly only use a request phase. Example transactions are send (put, write) and receive (get, read). The definition of transaction here further includes interrupts, (power management, debug, test) commands, and so-called side band signals, and so on.

The advantages and embodiments of the present invention are now described in more detail with respect to the figures.

### BRIEF DESCRIPTION OF THE DRAWINGS

FIG. 1 shows a block diagram of an architecture of an embodiment of a system on chip according to the invention,

FIGS. 2a and 2b show a block diagram of those components required in a communication in a network and a bus,

FIG. 3 shows a basic illustration of transaction-based and cycle-based traffic according to an embodiment of the invention,

FIGS. 4a to 4d show an illustration of an advance of system states via a communication control according to an embodiment of the invention, and

FIG. 5 shows a block diagram of an embodiment of an electronic device with a network on chip according to the invention.

### DETAILED DESCRIPTION OF EMBODIMENTS

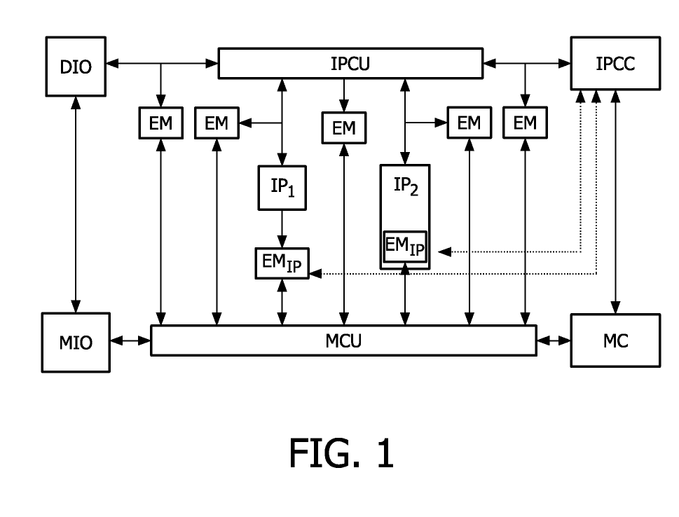

FIG. 1 shows a block diagram of an architecture of an embodiment of a system on chip according to the present invention. The system on chip comprises a plurality of intellectual property IP blocks IP which communicate with each other by an IP communication unit IPCU which may serve as an interconnect. The communication unit IPCU may be implemented as a single homogenous interconnect (e.g. routers or busses and bridges) or may comprise multiple heterogeneous interconnects (e.g. physically: switches, busses, routers, bridges, high speed, low speed or logically: data, control interrupt, debug and power management interconnects). An IP communication controller IPCC controls the traffic between the IP blocks IP via the IP communication unit IPCU. The IP communication controller IPCC can be implemented as a centralized controller or as distributed controllers. The system on chip according to the invention may be implemented on a single die or chip or may extend over multiple dies or chips, including FGPAs and emulators. Moreover, the communication unit (the interconnect) may include inter-die, inter-chip, inter-board, and board to (personal) computer interconnects, for prototyping or other purposes. In case of prototyping, some of the IP blocks may be simulated or emulated or be implemented on FPGA, emulator, or (personal) computer.

The IP blocks IP may be implemented as a processing unit and may constitute a processor, a co-processor, a DMA controller, a memory, a memory controller or the like.

The system on chip furthermore comprises a plurality of event monitors EM and at least one monitor controller MC. The event monitors EM serve to detect events in the communication (e.g. data traffic, control traffic, etc.) between IP blocks of the system on chip. The monitor controller MC is adapted to control the IP communication unit IPCU according to a detection of events by the event monitors EM. An event may be defined at various abstraction levels as for example a (low) level of bits, words per clock cycle or set of clock cycles at a higher level of transactions (read/write interrupts) or synchronization events, system configuration events or the like. The event monitors EM serve to detect whether predefined and/or programmable events occur and/or whether they occur in a predefined and/or programmable order, whether they are passing from the IP blocks IP unto the IP communication unit IPCU or within the IP communication unit IPCU (the interconnect). Furthermore, the event monitor EM may detect events regarding the communication unit IPCU (as interconnect) such as a network on chip buffer fillings or underflow or overflow, the dropping of packets, local or end-to-end flow control having certain values, packet or request or response message headers or payload having particular values, or the like. In addition to particular values, event monitors may monitor ranges of values, frequency of occurrence of particular values (or their ranges), and may combine multiple observations or events to a single compound or combined event, as well as combinations of all of the previous possibilities. Preferably, the event monitors EM are placed at strategic locations within the IP communication unit IPCU as interconnect and its interfaces. Accordingly, the event monitors EM can be connected to bus wires in a bus system or to routers or network interfaces, to links within a network. The interfaces may include interfaces with the IP blocks, I/O blocks DIO, the IP communication controller IPCC, internal or external memories and/or their controllers/interfaces, and/or external interfaces.

In addition, a monitor communication unit MCU or a monitor interconnect is provided which constitutes a dedicated communication or monitor interconnect for the monitor communication unit MCU and the event monitors EM. Alternatively, the IP communication unit IPCU can be used for this purpose.

The IP communication unit IPCU can be used such that the monitor controller MC may communicate with the IP communication unit IPCU for example to initiate a debug mode, an interruption of IP communication traffic and/or the states of the IP communication unit and/or the IP blocks onto on-chip or off-chip memory. The monitor controller MC may upload specifics regarding events to be detected and corresponding responses to the event monitors EM and the IP blocks IP as well as to the IP communication unit IPCU by means of the IP communication unit IPCU. This can for example be performed by defining the event monitors EM as memory-mapped components, or by addressing them with a monitoring /debug management protocol (like a power management protocol). In addition or alternatively, a dedicated monitor communication unit MCU may be used.

The monitor controller MC can be programmed via the event monitors EM, via an IP communication unit or via a dedicated test bus as JTAG or TAN. The monitor controllers can be addressed and programmed by defining the event controllers MC as memory-mapped components, or by addressing them with a monitoring/debug management protocol (like a power management protocol).

The event monitors EMIP coupled to the IP blocks IP may also be connected to the monitor communication unit MCU such that they can be controlled via the monitor controller MC. These event monitors EMIP for the IP blocks may be arranged outside an IP block or may be implemented inside the IP block. Furthermore, these units may utilize any existing monitor solutions. Therefore, the observation and control of the IP communication unit may be extended to the IP blocks IP enhancing the opportunities with respect to design, verification and debug of the electronic system.

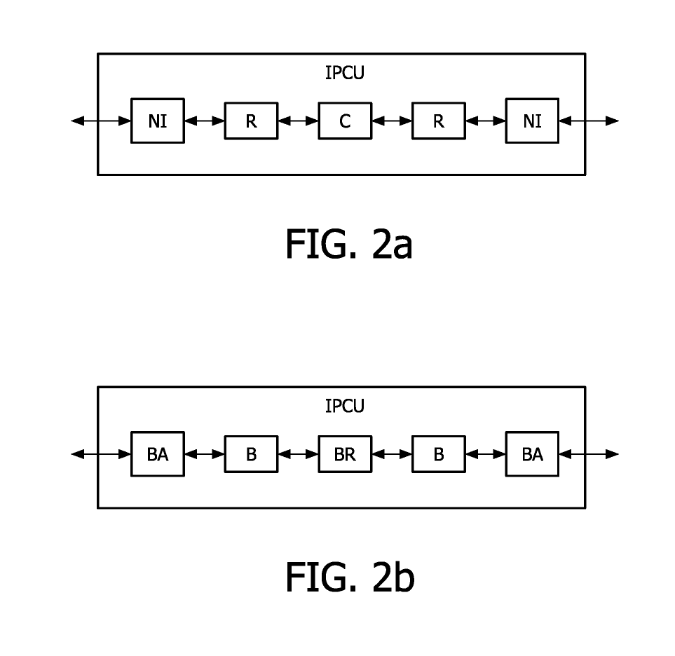

FIGS. 2a and 2b show an illustration of a block diagram of components of the communication unit as a network and as multiple busses. In FIG. 2a, the communication unit IPCU is implemented as a network-based interconnect, wherein the network comprises a plurality of network interfaces NI (to which the IP blocks may be coupled), a plurality of routers R and a plurality of channels. In FIG. 2b, the communication unit is implemented as a bus-based interconnect. The bus in turn will comprise several bus adapters BA, several busses B, a bridge BR as well as a further bus adapter BA (to which the IP blocks may be coupled).

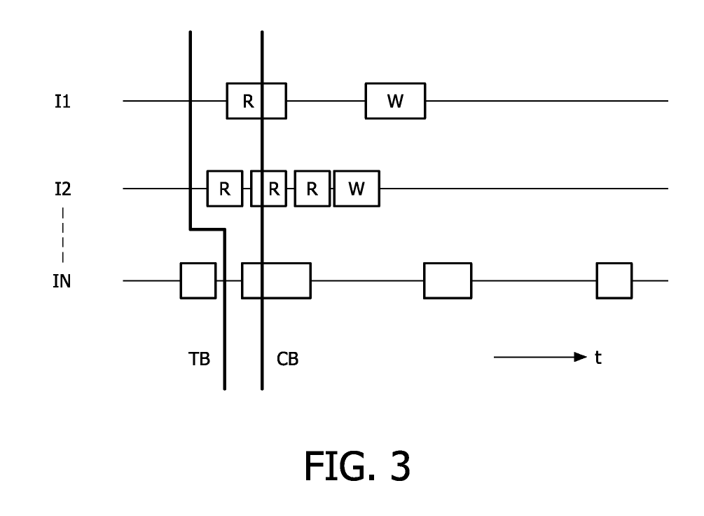

FIG. 3 shows a basic illustration of a transaction-based and a cycle-based traffic according to an embodiment of the invention. The transaction-based view is marked by TB while the cycle-based view is marked by CB. If the IP communication unit is implemented as a network-based interconnect, the data traffic will typically be divided into packets. If the IP communication unit is implemented as a bus-based interconnect, the data traffic will be divided into bits or words per clock cycle. However, in both cases, the data traffic needs to be reconstructed into time-coherent transactions. A transaction coherent view is defined by a state of the system where transactions at all relevant observation points are in a well-defined state (such as requests sent but no response received; requests sent and response pending). It should be noted that there may be no point in time where this is true and according to FIG. 3, the time/transaction coherent view combines multiple local views at different times into a global coherent view. The reconstruction of the packets for networks or the bits/words for busses into a time-coherent view can be complicated since it is possible that several transactions are concurrently active and may be split or pipelined. In addition, the transactions may be interrelated to each other. Therefore, if the reconstruction of the bits/words or packets into transactions is required, local and on-chip reconstruction may be preferred over off-chip reconstruction.

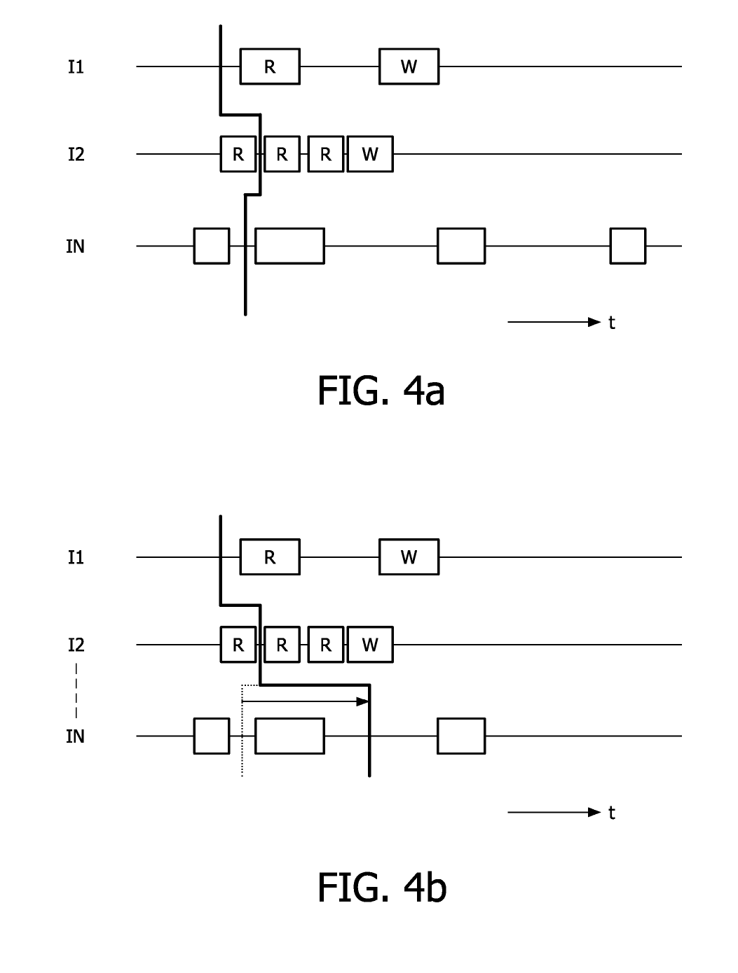

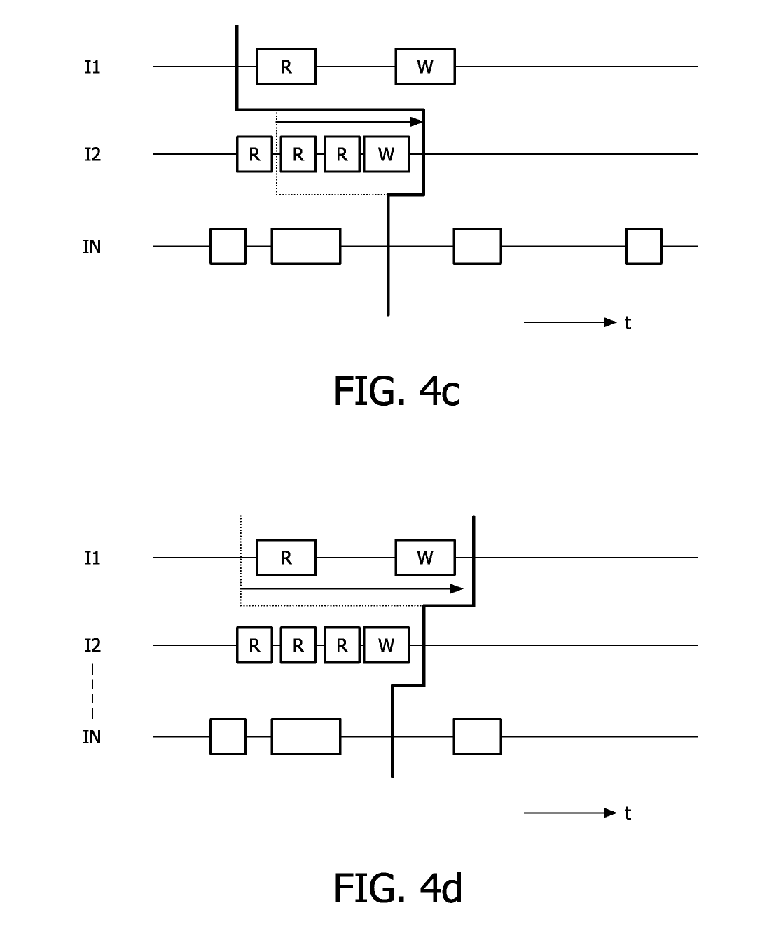

FIGS. 4a to 4d show an illustration of an advance of system states via a communication control according to an embodiment of the invention. In particular, different scenarios of the illustration of FIG. 3 are depicted. In FIG. 4a, a transaction-level stopping of the data traffic is shown. FIG. 4b depicts a stopping of a single-step in the interface IN. FIG. 4c shows a three-step stopping at interface I2. FIG. 4d depicts a two-step stopping at the interface I1. Another preferred way of stepping would be N steps in all interfaces. Accordingly, the communication via the IP communication unit can be stopped if an event or a sequence of events occur.

If according to a further embodiment a system debugging is to be implemented, the data communication via the IP communication unit IPCU is interrupted when predefined events are detected by the event monitors EM, which may e.g. correspond to transaction breakpoints. Accordingly, the transaction states of the IP blocks IP, the IP communication unit IPCU and/or the event monitors EM may be dumped or stored to background memory for further analysis. In particular, the transaction states which are to be dumped or stored on chip or off chip to background memory can be selected e.g. by means of the monitor controller. Hence, a coherent view on the actual active processes or transaction can be generated and stored in the memory. In addition, the transaction dumps can be performed via the monitor communication unit MCU and/or the IP communication unit IPCU, wherein the monitor communication unit MCU may comprise a low to medium bandwidth, while the IP communication unit IPCU may comprise a high bandwidth.

Preferably, the event monitors EM, the IP blocks IP and/or the IP communication unit nodes are configurable such that new transaction breakpoints can be loaded or updated in the event monitors and transaction can be uploaded to the IP blocks. Furthermore, if predefined events have been detected by the event monitors EM, the IP communication data traffic can be put under control either stepwise or selectively as shown in FIGS. 4a-4d.

According to a further embodiment, for a system performance monitoring and/or a local or global optimization, the above described event monitors EM may monitor the occurring transaction sequences and determine whether these monitored transaction sequences occur as expected or whether predefined transaction sequences are detected. If these do not occur as expected, the transaction sequences can be corrected during a system debug or can be optimized during the performance analysis of the system. By means of the event monitors EM the occurrence of specific transactions can also be counted. Furthermore, the event monitors EM may monitor the actual throughput of the communication units. Accordingly, by means of the event monitors EM it can be determined whether the actual electronic devices or electronic circuits in silicon meet the design requirements. If this is not the case, the system performance can be optimized for example by adapting the prioritization of the communication. This can be performed by interchanging best effort communications for guaranteed throughput communication in a network on chip. Alternatively, the admission of best effort traffic to the network on chip from within the network on chip can be regulated. The IP communication unit IPCU is used to write out transactions at various priorities. The various priorities may include a top priority claiming the entire network or bus to a low priority, e.g. for non-intrusive transaction dumped to the memory without interrupting the system operation.

Preferably, the event monitors EM may recognize events based on specific abstraction levels like a transaction level. Furthermore, the detected events may be compared to predefined or programmable events for communication components as busses, routers, network interfaces or the like. Furthermore, the detected events should be compared to predefined or programmable events for computation components. Moreover, the predefined or programmable events to be detected can be locally stored. Upon a detection, a time stamp can be associated to the detected event. Furthermore, the number of the occurrences of the events as well as their associated time stamps are detected.

To achieve the above-mentioned object, the monitor controller MC may be preferable coupled to the IP communication controller IPCC to control the operation of the IP communication controller IPCC to thereby control the operation of the IP communication unit IPCU in order to stop the data traffic (as shown in FIG. 4a-4d) and to restart the data traffic again. The stepwise restart of the data traffic may involve part or all of the system. This can for example be performed after refreshing and/or modifying the transactions at the IP block IP, the IP communication unit IPCU and/or the event monitors EM. Furthermore, the monitor controller MC controls the read out of transactions from the IP block, the IP communication unit IPCU and the event monitors EM at various levels of priority and/or non-intrusiveness.

As mentioned above, the communication between the event monitors EM and the monitor controller MC may be performed via a dedicated monitor communication unit MCU or via the IP communication unit IPCU. The dedicated monitor communication unit MCU may be implemented as a network or bus like DTL, AHB or JTAE.

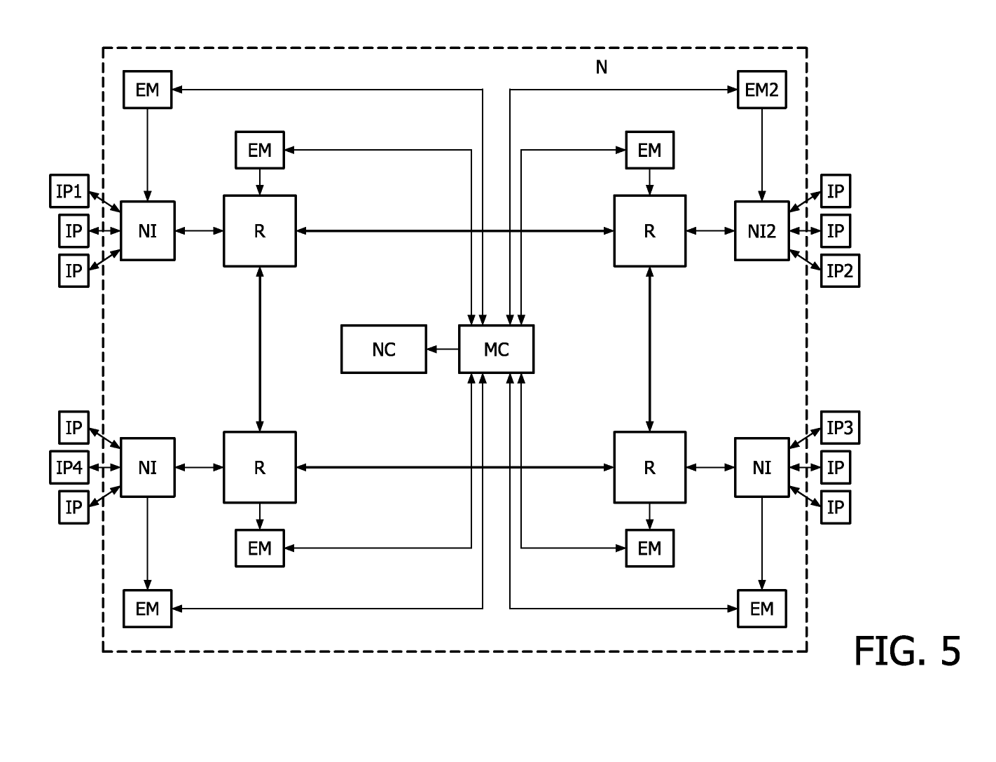

FIG. 5 shows a block diagram of a system on chip according to a second embodiment. Here, the interconnect is embodied as a network on chip N for coupling the IP blocks IP, IP1-4, wherein a network interface NI is associated to at least one of the IP blocks IP. The network on chip N may furthermore comprise a plurality of routers R which may be controlled by a network controller NC. Preferably, the event monitors EM are coupled to network interfaces NI to observe the data traffic to and from the IP blocks IP in order to detect events or transactions. The location of the event monitors EM adjacent to a network interface NI is advantageous as the network interface NI is responsible for requests for an acknowledgement of established network paths. Furthermore, the IP data is packetized and network packages are decomposed in the network interface NI. In contrast to the implementation of FIG. 1 where event monitors EM are coupled directly to the IP blocks, the number of event monitors EM according to the second embodiment can be kept low. In addition, event monitors EM may be coupled to the routers R in the network on chip in order to monitor the communication traffic on the network on chip to detect events. In addition, event monitors EM may also be connected to the monitor controller MC. The monitor controller MC is adapted to control the network controller NC which corresponds to the IP communication controller IPCC to stop the data traffic over the network on chip if required. In this embodiment, the monitor communication unit and the IP communication unit are implemented as the network on chip. According to FIG. 5, the interconnect N includes the event monitors EM and the monitor controller MC. However, the actual contribution of the interconnect N according to the present invention with respect to the known interconnect N would rather be represented by a configuration where the event monitors EM and the monitor controller MC are located outside the dashed box of FIG. 5.

In an illustrative example, all transactions may fit into a single packet. All packets can be delivered through a single path or a single connection. Alternatively or additionally, transactions may be split or may stretch over multiple packets. Furthermore, the packets may also travel along different paths. According to an illustrative example, the processor IP1 has to read data from the memory IP2 when the data has been refreshed by processor IP3. The refreshing by the processor IP3 can be monitored by the event monitor EM2 which is coupled to the network interface NI2. The event monitor EM2 may be configured to determine when the processor IP3 refreshes data in the memory IP2. Therefore, if the event monitor EM2 detects that the processor IP3 has refreshed data in the memory IP2, this information is forwarded to the monitor controller MC which may stop all network communication if two read actions of the processor IP1 follow after a single write action by the processor IP3. If the network communication is stopped, the states of the selected network interfaces and routers, which are required to monitor whether the processor IP3 has already submitted new data or whether the data is stored within the network, can be dumped for further analysis.

The analysis of the determined states of the network interfaces and routers may be analyzed by setting up network paths to the IP block IP4 which serves as an I/O unit. The network path to the I/O unit IP4 serves to forward the determined states for an off-chip analysis. It should be noted that a state dump on a transaction level instead of a bit level forwarding of the states reduces the amount of data to be forwarded to the off-chip analysis.

If data generation problems occur within the processor IP3, an appropriate value can be uploaded into the memory IP2 and the operation of the system may continue continuously or in a stepwise mode. If the system is stopped, the user can analyze the states of (packets located at) selected network interfaces NI's and routers to monitor whether the processor IP3 has already submitted new data or whether the data (packet) is stalled somewhere in the network. In the software as well as in the hardware design, the states could be analyzed from the design database, however, for an analysis of actual silicon the user needs to set-up networks paths to e.g. (IO block) IP4 to dump states off-chip for analysis. A silicon state-dump on transaction-level, instead of the current bit-level, reduces the amount of data to be shifted-out and eases the comparison with software and hardware design databases.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single . . . or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Electronic device, comprising:
a plurality of processing units (IP; IP1-IP4),
an interconnect (IPCU; N) for coupling the processing units (IP; IP1-IP4) to enable a communication between the processing units (IP; IP1-IP4),
at least one event monitor (EM) for detecting events in communications between the processing units (IP; IP1-IP4), and
a first controller unit for controlling the interconnect (IPCU; N) according to one or more events detected by at least one event monitor (EM).

2. Electronic device according to claim 1, wherein the controller unit comprises a monitor controller (MC) and/or an interconnect controller (IPCC; NC) for controlling the communication between the processing units via the interconnect (IPCU; N).

3. Electronic device according to claim 2, wherein the monitor controller (MC) is adapted to update settings in the event monitors (EM), in the processing units (IP) and/or in the interconnect controller (IPCC; NC) or the interconnect (IPCU; N) directly.

4. Electronic device according to claim 1, wherein an event monitor (EM) is associated to at least one of the processing units (IP), the interconnect (IPCU) and an I/O-interface (IO) or a monitor interface (MIO).

5. Electronic device according to claim 3, wherein the event monitors (EM), the monitor controller (MC), the interconnect controller (IPCC; NC), and/or the interconnect (IPCU) operate on transactions.

6. Electronic device according to claim 1, wherein the events include predefined or programmable sequences of predefined and/or programmable events.

7. Electronic device according to claim 1, wherein the control unit is adapted to control the interconnect (IPCU; N) to perform predefined or programmable sequences of predefined or programmable operations and/or actions.

8. Electronic device according to claim 7, wherein predefined or programmable operations can be control-oriented and/or data-oriented operations, wherein the control-oriented operations include stopping, single-step, multi-step, continue, and reset operations, and wherein the data-oriented operations include output and input of interconnect states and/or states of the processing units.

9. Electronic device according to claim 6, wherein the granularity of control-oriented operations can be on a clock-cycle-level, on hand-shakes, on requests/responses, on transactions, or on transaction groups.

10. Electronic device according to claim 6, wherein the monitor controller (MC) is adapted to output or input states of the processing units (IP; IP1-IP4), the interconnect (IPCU; N), the event monitors (EM) and/or the first controller unit.

11. Electronic device according to claim 1, wherein the interconnect (IPCU; N) constitutes a network-based interconnect or a bus-based interconnect.

12. Electronic device according to claim 1, furthermore comprising a monitor communication unit (MCU) for coupling the event monitors (EM) and the controller unit.

13. Electronic device according to claim 1, wherein the first controller unit comprises an interconnect controller (IPCC; NC) and/or a monitor controller (MC).

14. Electronic device according to claim 1, wherein at least one of the plurality of processing units comprises an on-chip memory or an off-chip memory or a memory controller.

15. System on chip, comprising:
a plurality of processing units (IP; IP1-IP4),
an interconnect (IPCU; N) for coupling the processing units (IP; IP1-IP4) to enable a communication between the processing units (IP; IP1-IP4),
at least one event monitor (EM) for detecting events in communications between the processing units (IP; IP1-IP4), and
a first controller unit for controlling the interconnect (IPCU; N) according to one or more events detected by at least one event monitor (EM).

16. Method of controlling a communication in an electronic device and/or a system on chip having a plurality of processing units (IP; IP1-IP4) and an interconnect for coupling the processing units (IP; IP1-IP4) to enable a communication between the processing units (IP; IP1-IP4), comprising the steps of:
detecting events in a communication between the processing units (IP; IP1-IP4), and
controlling the interconnect according to one of the events detected by the at least one event monitor.
